(19) United States
(12) Patent Application Publication
(10) Pub. No.: US 2025/0353099 A1
(43) Pub. Date: Nov. 20, 2025

(54) WELDING METHOD AND WELDING DEVICE

(71) Applicant: Fronius International GmbH, Pettenbach (AT)

(72) Inventors: Peter LATTNER, Wels-Thalheim (AT); Dominik SÖLLINGER, Wels-Thalheim (AT)

(73) Assignee: Fronius International GmbH, Pettenbach (AT)

(21) Appl. No.: 18/880,118

(22) PCT Filed: Jun. 27, 2023
(86) PCT No.: PCT/EP2023/067365

§ 371 Date: Dec. 30, 2024

(30) Foreign Application Priority Data
Jun. 30, 2022 (EP) 22182388.3

(51) Int. Cl. B23K 9/12; B23K 9/167

(52) U.S. Cl. CPC B23K 9/124; B23K 9/167

(57) ABSTRACT

A welding method and to a corresponding welding device including a heat source and a welding filler material in the form of a welding wire, to achieve a welding quality that is as high and consistent as possible simply and independently of the skill of the welder. The welding wire is fed to the molten bath in intermittent feed cycles; while carrying out the method, an actual value is determined for a duration of a first time period of the feed cycles in which the welding wire does not contact the molten bath, and/or an actual value is determined for a duration of a second time period of the feed cycles in which the welding wire does contact the molten bath; and at least one predefined parameter of the feed speed of the welding wire is changed in the feed cycles, depending on the determined actual value and a predefined target value.

The invention relates to a welding method, wherein energy is introduced into a workpiece in the region of a welding point by means of a non-consumable electrode as a heat source in order to produce a molten bath, wherein a welding wire separate from the heat source is fed to the molten bath and wherein the welding wire is melted by the introduced energy in the region of the molten bath in order to produce a weld seam on the workpiece. The invention further relates to a welding device comprising a welding torch with a non-consumable electrode as a heat source for introducing energy at a welding point on a workpiece in order to produce a molten bath, comprising a feed device for feeding a welding wire separate from the heat source to the molten bath, wherein the welding wire can be melted in the region of the molten bath by the energy introduced by the heat source in order to produce a weld seam on the workpiece, and comprising a control unit for controlling the feed device.

The invention generally relates to such welding devices comprising a welding torch with a heat source for introducing energy at a welding point on the workpiece in order to produce a molten bath, wherein a separate additive in the form of a welding wire is supplied to the molten bath independently of the heat source. The welding wire is likewise melted by the energy of the heat source in order to produce a weld seam on the workpiece. Examples of that are the well-known TIG (tungsten inert gas) welding process, in which a non-consumable electrode made of tungsten or of a tungsten alloy is used as a heat source, the well-known plasma welding process, in which a non-consumable electrode is likewise used, or the well-known laser welding process, in which laser optics are used as a heat source.

In TIG welding, an arc is generated between the electrode and the workpiece, which on the one hand produces the molten bath on the workpiece and on the other hand melts the welding wire. In laser welding, the laser optics generate a laser beam, which produces the molten bath and melts the supplied welding wire. A combination of TIG welding and laser welding is also known; this is also referred to as TIG/laser hybrid welding.

Therein, the molten bath is produced on the one hand by the energy of the arc and on the other hand by the energy of the laser beam. In all cases, the additive is fed separately in the form of a welding wire, which is usually done by a feed unit.

A distinction must be made between the welding methods mentioned and welding methods with consumable electrodes, in which the welding wire is used directly as an electrode, such as the well-known MIG/MAG welding process. No separate additive is required here, but instead the electrode at the same time forms the welding wire. These welding methods are not covered by the invention.

In TIG welding, a welding current is passed across the electrode to establish and maintain the arc between the electrode and the workpiece. An inert shielding gas (usually argon or helium) is usually also used to prevent the melt from coming into contact with the ambient air. In addition, an electric heating current can also be introduced into the welding wire in order to electrically heat the welding wire and to assist in the melting of the filler material.

In most cases the welding wire is fed to the welding point by means of a feed unit. As a rule, a preset or adjustable, usually constant, value is used for the feed speed, which may depend on the set welding current level. However, during this process, it happens that the welding wire again and again dips too deeply into the molten bath or that the welding wire loses contact with the molten bath and moves too far away from the molten bath. In both of these cases, the welding result is worsened which can lead to uneven weld seams or to defects in the weld seam. This happens in particular when the welding torch is operated manually, since certain parameters that affect the energy acting on the welding wire cannot always be precisely adhered to by the welder. These influencing parameters include, for example, the distance between the welding torch and the workpiece or an angle between the welding wire and the electrode. However, this can also occur with robot-guided welding torches, for example when welding more complex geometries and/or with different welding speeds.

In order to eliminate this problem, it has already become known from WO 2010/082081 A1 to use the heating current through the welding wire in order to detect the change in voltage between the welding wire and the workpiece. If the change in voltage exceeds a specified limit value, the heating current is reduced to a very small value for a defined period of time in order to prevent the welding wire from melting quickly. With the remaining small heating current, the renewed contact of the welding wire with the workpiece (more precisely with the weld pool) is detected. Such contact causes a short circuit, as a result of which the voltage between the welding wire and the workpiece drops to zero. If renewed contact is identified, the heating current through the welding wire is increased again. This method can thus only be used for hot wire applications (with additional heating of the welding wire by means of a heating current), but not for cold wire applications (without such a heating current).

In JP 60-036860 B, the electrical potential that is established around the electrode is evaluated in order to change the position of the welding wire relative to the workpiece. The electrical potential can be measured as voltage between the welding wire and the workpiece and is used to deduce the dipping position of the welding wire into the weld pool. This is used to control the position of the welding wire relative to the workpiece, specifically the distance between the welding wire and the workpiece, in order to set an optimum dipping position. This method is based on the fact that there is always contact between the weld pool and the welding wire. However, this means that there is practically always a short circuit between the welding wire and the workpiece, and the detectable voltages are very small and in a very narrow range, which makes the method prone to failure and unreliable. Apart from this, an additional controller and actuator are required to be able to adjust the position of the welding wire relative to the workpiece and also relative to the welding torch.

Document US 2020/246902 A1 further relates to a MIG/MAG welding method in which a sum of durations is changed during welding. However, since this is a MIG/MAG welding method, the specifics and special problems of TIG welding methods are addressed only inadequately.

It is therefore an object of the present invention to provide a welding method and a corresponding welding device comprising a heat source and a welding filler material in the form of a welding wire, by means of which a welding quality as high as possible and as consistent as possible can be achieved simply and independently of the skill of a welder.

This object is achieved according to the invention by the welding method mentioned at the outset in that the welding wire is fed to the molten bath in intermittent feed cycles, preferably with a reversing feed speed, in that, while performing the welding method, an actual value of a duration of a first time period of a feed cycle is determined in each case, in which first time period the welding wire does not come into contact with the molten bath, and/or an actual value of a duration of a second time period of a feed cycle is determined in each case, in which second time period the welding wire does come into contact with the molten bath, and in that at least one specified parameter of the feed speed of the welding wire is changed in the feed cycles, depending on the determined actual value and a predefined target value. Preferably, an average feed speed of an entire feed cycle and/or an average positive feed speed of a feed cycle and/or an average negative feed speed of a feed cycle is used as a parameter of the feed speed. A feed cycle consists of a first time period with a positive feed speed of the welding wire and a subsequent second time period with a feed speed of zero or with a negative feed speed. With the welding method according to the invention, the feed speed parameter can thus be continuously adjusted in order to realize the target value. This makes it possible to produce a uniform weld seam of high quality, substantially independently of the variable parameters mentioned above. Also a plurality of the parameters mentioned can be changed.

According to the invention, the duration of the first time period of a feed cycle is determined as the actual value and a target value for the first duration is used as the target value, or the duration of the second time period of a feed cycle is determined as the actual value and a target value for the second duration is used as the target value, or a sum of the duration of the first time period and the duration of the second time period of a feed cycle is determined as the actual value and a target value for a drop transfer frequency is used as the target value. For example, if it is found that the current duration of the first time period is longer than the predefined target value, then the parameter of the feed speed of the welding wire is changed in order to adjust the target value, e.g. the average feed speed per cycle or the average positive feed speed per cycle can be changed, in particular increased. Conversely, if it is found, for example, that the current duration of the first time period is shorter than the predefined target value, then the average feed speed of the welding wire or the average positive feed speed is reduced. As a result, it is possible for the duration of the first period of time in which the welding wire does not touch the molten bath to be kept substantially constant throughout the welding process. As an alternative to the first time period, the second time period in which the welding wire does come into contact with the molten bath can of course also be used. The second time period substantially corresponds to the time period between two consecutive first time periods. A sum of the duration of the first time period and the duration of the second time period, which corresponds to a drop transfer frequency, can also be used.

The average feed speed or the average positive feed speed can be changed, for example, by setting the feed speed to a defined first positive value for a defined boost time at the beginning of each feed cycle and reducing it from the first value to a defined second positive value after the boost time has elapsed, wherein the first value and/or a ratio between the first value and the second value and/or a length of the boost time can preferably be set as a function of an error between the determined actual value and the predefined target value. This allows the average feed speed or the average positive feed speed to be easily changed, and adverse effects due to the inertia of the welding wire can be advantageously reduced.

Preferably, the energy is introduced into the workpiece via an electric arc produced between a non-consumable electrode and the workpiece. This allows the invention to be used in the known TIG welding method. Alternatively or additionally, the energy can also be introduced into the workpiece by a laser beam generated by laser optics. This allows the invention to be used in the laser welding method or laser hybrid welding method.

The actual value of the duration of the first time period and/or the actual value of the duration of the second time period can be determined continuously or discretely. For example, a time-discrete determination can only be carried out in the time steps of the regulation mentioned below, which means that no uninterrupted determination is required.

The predefined target value is preferably achieved by changing at least one parameter of the feed speed. This allows feedback control to be used, which makes possible a very precise adjustment of the target value. This means that consistent welding quality can be achieved regardless of interfering influences.

The target value can be determined, for example, as a function of a diameter of the welding wire and/or as a function of a material of the welding wire and/or as a function of an electrical welding parameter, in particular a welding current, and/or as a function of a seam shape of the weld seam. This allows various influencing parameters to be taken into account when selecting the target value, which means that the method can be flexibly adapted to specific boundary conditions. The target value can be set by the welder, for example via a user interface, or selected from existing values.

Preferably, an electric potential is tapped at the welding wire and the actual value of the duration of the first time period and/or the actual value of the duration of the second time period are determined from a time profile of the detected electric potential. This makes it easy to detect when and for how long the welding wire comes into contact with the workpiece.

The electric potential can be tapped, for example, by measuring a measuring voltage between the welding wire and the workpiece and/or an electrical measuring current flowing through the welding wire and determining the actual value of the duration of the first time period and/or the actual value of the duration of the second time period from a time profile of the measuring voltage and/or the measuring current. Optionally, an additional electrical ground potential could be generated between the welding wire and the workpiece to make possible a measurement at any time, even when there is no electric potential around the welding wire.

The object is also achieved with the welding device mentioned at the outset in that the control unit is designed to control the feed device in such a way that the welding wire can be fed to the molten bath in intermittent feed cycles, preferably with a reversing feed speed, in that a determination unit is provided which is designed to determine, during a welding method carried out with the welding device, an actual value of a duration of a first time period of a feed cycle in which the welding wire does not come into contact with the molten bath and/or to determine an actual value of a duration of a second time period of a feed cycle in which the welding wire does come into contact with the molten bath, and in that the control unit is designed to control the feed device in order to change at least one specified parameter of the feed speed of the welding wire in the feed cycles depending on the determined actual value and a predefined target value.

Advantageous embodiments of the welding device are specified in claims 9 to 14.

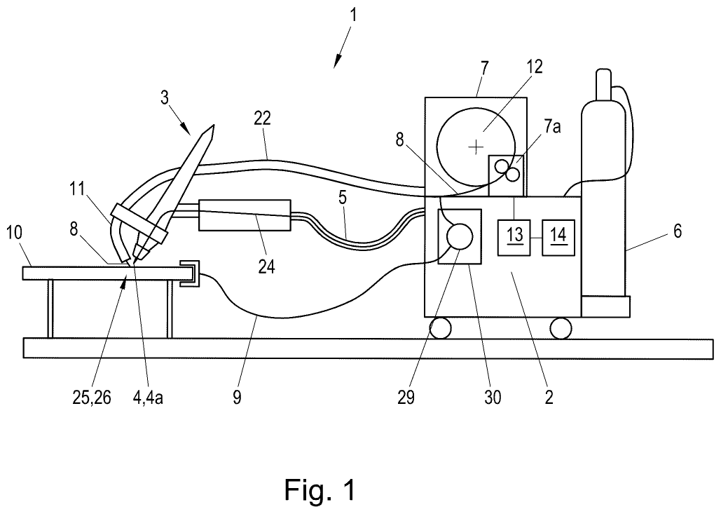

The present invention will be described in greater detail below with reference to FIGS. 1 to 4, which by way of example show schematic and non-limiting advantageous embodiments of the invention. In the figures:

FIG. 1 shows a welding device with a welding torch with a non-consumable electrode,

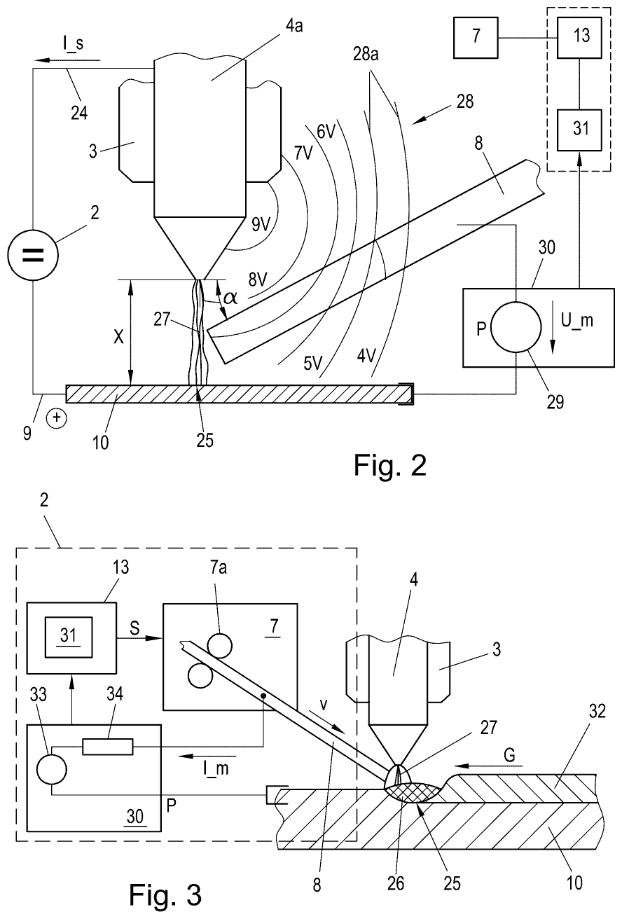

FIG. 2 shows a non-consumable electrode with a potential field around the arc caused by the welding current,

FIG. 3 shows an advantageous embodiment of the welding device according to the invention,

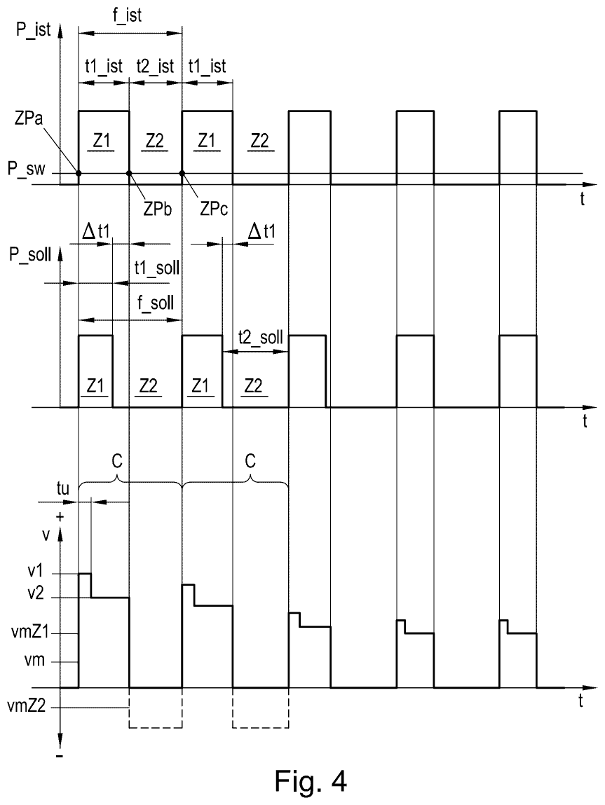

FIG. 4 shows time profiles of an actual value of the potential, of a target value of the potential and of a feed speed of the welding wire.

FIG. 1 shows a welding device 1 in the form of a TIG welding device. The welding device 1 has a welding current source 2 and a welding torch 3 on which a heat source 4 in the form of a non-consumable electrode 4a is arranged, e.g. a tungsten electrode. Within the scope of the invention, however, the heat source 4 could alternatively or in addition to the non-consumable electrode 4a also have laser optics (not shown). For the sake of simplicity, the invention will be described below only with reference to TIG welding, but is of course also applicable in an analogous manner to laser welding or to the TIG/laser hybrid welding process mentioned at the beginning.

In the example shown, the welding torch 3 is connected to the welding current source 2 by means of a hose package 5. In addition, a shielding gas container 6 is provided. Usual cylinder fittings on the shielding gas container 6, for example for setting the flow of shielding gas, are not shown. Furthermore, a feed unit 7 is provided in order to supply the welding wire 8 as a welding filler material to the welding point 25. The feed unit 7 can be part of the welding current source 2, but can also be designed as an independent unit. In the feed unit 7, a welding wire roll 12 is arranged from which the welding wire 8 is unrolled during welding and is supplied to the welding point 25 at a feed speed v. To generate the feed speed v, the feed unit 7 has a suitable and sufficiently powerful drive unit 7a.

Further, a control unit 13 is provided for controlling the welding device 1. Within the scope of the invention, the control unit 13 is at least designed to control the feed unit 7, in particular the drive unit 7a, in order to set the feed speed v of the welding wire 8 to a desired value. Within the scope of the invention, the welding wire 8 is fed to the welding point in intermittent feed cycles, as will be explained in more detail below with reference to FIG. 3. A feed cycle C has a first time period with a positive feed speed v and a second time period Z2 with a feed speed of zero or a negative feed speed (in case of reversing wire feed). The control unit 13 can have suitable hardware and/or software in a known manner. Preferably, however, the control unit 13 is also designed to control the welding method carried out with the welding device 1. In addition to controlling the feed speed v, the control unit 13 can thus also control or regulate the welding parameters of a welding process being carried out, e.g. the welding current I_s, the welding voltage U_s, a frequency of the welding current I_s or welding voltage U_s, the amount of shielding gas supplied, etc. Of course, several separate control units could also be provided which communicate with one another via a suitable communication connection in order to exchange control variables. However, controlling the feed speed v is essential for the invention, so that in the following reference is mainly made only to the control unit 13.

In the welding device 1, a user interface 14 can also be provided which communicates with the control unit 13 in a suitable manner. Via the user interface 14, a welder can, for example, select a welding program or a specific welding process with prespecified welding parameters (e.g. a pulse welding process with a specific welding current I_s and a specific frequency). Likewise, certain settings can be selected or changed manually. For example, the feed speed v of the welding wire 8 has previously usually been specified by the welder or selected from available values and was usually constant.

In the hose package 5, all required media, energy and control signals can be transmitted to the welding torch 3, for example electrical energy (current, voltage), a cooling medium (if the welding torch 3 is cooled), control lines for controlling the welding process, the shielding gas of the shielding gas container 6 or of the welding wire 8. Usually a hose in which the individual lines and media are guided is provided as the hose package 5. Of course, a plurality of separate hoses or lines can also be provided.

The electrical counter-pole (usually the positive pole) contacts the workpiece to be welded 10 via a contact line 9. The contact line 9 is often also referred to as the ground line. A welding wire feeder 11 can also be arranged on the welding torch 3 in order to be able to supply the welding wire 8 in a desired position and direction relative to the electrode 4a of the welding point 25. The welding wire feeder 11 can also be connected to a welding wire line 22 in which the welding wire 8 is guided to the welding wire supply 11 separately, i.e. outside the hose package 5. However, the welding wire supply 11 does not necessarily have to be arranged on the welding torch 3, but can also be arranged at any other suitable location, for example on a welding robot. Even the feed unit 7 does not necessarily have to be arranged on the welding current source 2 either, but can also be arranged at any other suitable location, for example on a welding robot.

A contact sleeve (not shown) is usually arranged on the welding torch 3, which surrounds the electrode 4a and makes electrical contact therewith and which is connected to the welding current source 2 (usually to the negative pole) via a welding current line 24, usually routed within the hose package 5. The electrode 4a protrudes from the welding torch 3 at one end of the welding torch 3. Shielding gas can emerge from the welding torch 3 around the electrode 4a, said gas surrounding the welding point 25 with the molten bath 26 and shielding it from the ambient atmosphere (as indicated in FIG. 3). During welding, the welding wire 8 is fed to the welding point 25 in intermittent feed cycles C, optionally with reversing wire feed. Reversing wire feed means that a positive feed speed is used in the first time period Z1 and a negative feed speed in the second time period Z2. Since the basic structure and the basic function, and the various modifications thereto, of such a welding device 1 are known, they will not be discussed in more detail here.

As mentioned previously, laser optics (not shown) could also be provided as the heat source 4 instead of in addition to the electrode 4a shown. Heat is introduced into the workpiece 10 by a laser beam in addition to or as an alternative to the arc 27 (see FIG. 2). During pure laser welding (i.e. without electrode 4a), the electrical lines 24, 9 are known to be unnecessary since no arc needs to be ignited. Apart from that, the structure of the welding device 1 is essentially identical. In particular, during laser welding as well, a welding wire 8 is fed to the welding point 25 by a feed unit 7.

FIG. 2 shows a more detailed view of the welding torch 3 in the region of the tip of the non-consumable electrode 4a, which is located at a welding point 25 on the workpiece 10. The welding current source 2 generates a welding current I_s (e.g. in the region of 100A), which is passed through the electrode 4a via the welding line 24 in order to generate or maintain an arc 27 between the electrode 4a and the workpiece 10. Known methods can be used to ignite the arc 27, for example high-frequency ignition or ignition by touching the workpiece 10 with the electrode 4a and then lifting off the electrode 4a. When the welding current I_s flows through the electrode 4a, a quasi-static electric field 28 is formed around the electrode 4a in a known manner, as indicated in FIG. 2.

This quasi-static electric field 28 leads to a distribution of potential in the vicinity of the electrode 4a, as indicated by equipotential lines 28a in FIG. 2. In principle, the values are dependent on, amongst other things, the welding current, cooling of the electrode, shielding gas, arc length (distance A), etc., but can be assumed to be known. This potential P can be detected as an electric variable, e.g. as a measuring voltage U_m or as an electrical measuring current I_s, by a suitable potential detection unit 30. For this purpose, the potential detection unit 30 can, for example, have a voltage measuring device 29 with which the measuring voltage U_m can be tapped against a reference potential. In FIG. 2, on the equipotential lines 28a, exemplary voltage values against the potential P of the workpiece 10 are shown as reference potential. This electric potential P is tapped via the welding wire 8 which is supplied to the welding point 25 and is therefore within the quasi-static electric field, and is measured with the voltage measuring device 29. For this purpose, no separate measuring current has to be passed through the welding wire 8. Likewise, a possible heating current for heating the welding wire 8 interferes equally little with the detection of the potential P. The potential P can thus be tapped in both cold wire and hot wire applications.

Instead of a measuring voltage U_m, an electrical measuring current I_m flowing through the welding wire 8, which is caused by the potential P, can also be measured in an analogous manner, as shown by way of example in FIG. 3. For this purpose, for example, a terminating resistor 34 can be connected between the welding wire 8 and the workpiece 10, along which an electric current flows which can be measured as measuring current I_m in order to record the potential P. The potential detection unit 30 has a suitable current measuring device 33, as shown in FIG. 3. Of course, instead of measuring current I_m and measuring voltage U_m, another electrical variable related to the potential distribution could be recorded or determined in the same way, for example, a resistance or power could be determined from the measuring voltage U_m and measuring current I_m. Within the scope of the invention, tapping the electric potential P therefore includes all of these possibilities.

As suggested in FIG. 3, the potential detection unit 30 can be arranged, for example, in the welding current source 2 in which the reference potential of the workpiece 10 is present anyway, for example via the contact line 9 or a separate line for contacting the workpiece 10. The use of the contact line 9 is advantageous since an additional line can then be dispensed with. When the contact line 9 is used, the potential detection unit 30 can be connected to the terminal of the contact line 9 (ground socket) on the welding device 1, for example. It is only necessary to additionally provide the potential detection unit 30 in the welding device 1 in order to record an electrical variable representing the electrical potential P, for example the measuring voltage U_m. For this purpose, an electrical contact can simply be implemented on the welding wire 8, for example as a sliding contact in the feed unit 7. If necessary, a terminating resistor 34, which can also be part of the potential detection unit 30, can be provided between the welding wire 8 and the workpiece, or the contact line 9, or another reference potential.

From the electrical variable representative of the potential P (measurement voltage U_m, measurement current I_m, etc.), it can be easily determined, on the basis of the resulting potential distribution, whether the welding wire 8 comes into contact with the molten bath 26 generated by the electrode 4a through the arc 27 or whether the welding wire 8 is too far away from the molten bath 26 and does not come into contact with the molten bath 26. When the welding wire 8 comes into contact with the molten bath 26, a short circuit occurs, causing the measuring voltage U_m measured by the voltage measuring device 29 to drop to zero (or essentially zero) or the measuring current I_m measured by the current measuring unit 33 to drop to zero (or essentially zero). The same applies to any values derived therefrom. Conversely, when the welding wire 8 does not come into contact with the molten bath 26, a certain measuring current I_m or a certain measuring voltage U_m will be measured, which depend on the level of the potential P.

An additional auxiliary energy source (not shown) may also be provided in the measuring circuit of the potential detection unit 30 in order to generate a certain ground potential. This is advantageous for applications in which no or only a small electric field forms around the heat source 4, such as in pure laser welding in which the heat source 4 has laser optics 4a. The auxiliary energy source ensures that a measurable electrical potential is available at all times, independently of the potential P of the electrical field, which can be used for the measurement. The auxiliary energy source can, for example, be designed as a high-impedance voltage source with which an auxiliary voltage can be applied to the welding wire 8. This means that during TIG welding, for example, a potential P could be detected even before the arc 27 is ignited and can be used to determine whether the welding wire 8 is in contact with the workpiece 10, in particular whether a short circuit is present.

According to the invention, a determination unit 31 is further provided which is designed to determine, during the execution of the welding method, an actual value t1_ist of a duration t1 of a first time period Z1 of a feed cycle C in which the welding wire 8 does not come into contact with the molten bath 26 or the workpiece 10. Alternatively or additionally, the determination unit 31 could also be designed to determine an actual value t2_ist of a duration t2 of a second time period Z2 of a feed cycle C in which the welding wire 8 does come into contact with the molten bath 26 or the workpiece 10. The durations t1, t2 and the time periods Z1, Z2 are shown in FIG. 4.

The determination unit 31 can be designed as a separate unit having suitable hardware and/or software and communicating with the control unit 13 via a suitable communication connection, as indicated in FIG. 2. Advantageously, however, the detection unit 31 is integrated in the control unit 13, as indicated in FIG. 3. According to the invention, the control unit 13 is designed to control the feed device 7, in particular the drive unit 7a, in order to set at least one defined parameter of the feed speed v of the welding wire 8 depending on the determined actual values t1_ist and/or t2_ist and a predefined target value.

The detection unit 31 can easily detect from the electrical variable representative of the potential P (measurement voltage U_m, measurement current I_m, etc.) on the basis of the resulting potential distribution whether the welding wire 8 comes into contact with the molten bath 26 generated by the electrode 4a through the arc 27 (short circuit) or whether the welding wire 8 is too far away from the molten bath 26 (no short circuit). The duration t1 of the first time period Z1 (no short circuit) or the duration t2 of the second time period Z2 (short circuit) can be determined from the time profile of the detected electrical variable representative of the potential P, as shown in FIG. 4.

In FIG. 4, the upper diagram shows an exemplary time profile of a detected potential P. The profile thus corresponds to a profile of an actual value P_ist of the potential P measured by the potential detection unit 30. Depending on the measured variable, this can be, for example, a profile of the measuring current I_m or a profile of the measuring voltage U_m. The middle diagram shows a correlating time profile of a target value P_soll of the potential P. The lower diagram shows a correlating time profile of the feed speed v of the welding wire 8. It can be seen that the welding wire 8 is supplied to the molten bath 26 in intermittent feed cycles C with a time-varying feed speed v. The feed speed v is set to a certain positive value in each cycle C in the first time period Z1, here values v1, v2 (for the sake of simplicity, shown only for the first cycle C in FIG. 4). In the subsequent second time period Z2 of cycle C, a feed speed v=0 is used in the example shown. Alternatively, a reversing wire feed can be used, in which a negative feed speed v is used in the second time period Z2, as indicated by the dashed line for two feed cycles C. A negative feed speed v corresponds to a movement of the welding wire back and away from the molten bath 26 and a positive feed speed v corresponds to a movement in the direction of the molten bath 26.

During the respective first time periods Z1, the welding wire 8 is not in contact with the molten bath 26. The first time periods Z1 thus correspond to a short-circuit-free time in which the potential P_ist measured by the potential detection unit 30 is greater than zero or greater than a defined value that represents the short circuit. The second time periods Z2 lying between two first time periods Z1 correspond to a short-circuit time in which the potential P_ist measured by the potential detection unit 30 is zero or assumes a value that represents a short circuit. The determination unit 31 can determine the current duration t1_ist of the first time periods Z1 from the actual value profile P_ist, i.e. the length of the short-circuit-free time. Alternatively, the determination unit 31 can also determine the current duration t2_ist of the second time periods Z2, i.e. the length of the short-circuit time, from the actual value profile P_ist. The duration of an entire feed cycle C can also be determined, which corresponds to a sum of the duration t1_ist of the first time period Z1 and of the duration t2_ist of the second time period Z2. This is also referred to as a so-called droplet detachment frequency f. In FIG. 3, the current droplet detachment frequency f_ist and the desired target value f_soll of the droplet detachment frequency f are shown by way of example for a feed cycle C.

For example, a certain threshold value P_sw, which represents a short circuit, could be set for the potential P. The threshold value P_sw can be zero or slightly higher. In FIG. 4, by way of example a threshold value P_sw is shown that is slightly higher than zero. The actual value t1_ist of the duration t1 can then be determined, for example, by measuring a time between a point in time ZPa, at which the measured potential P_ist (e.g. welding current I_s or welding voltage U_s) exceeds the defined threshold value P_sw, and a subsequent point in time ZPb, at which the measured potential P_ist again falls below the defined threshold value P_sw. In an analogous manner, the duration t2 between a point in time ZPb at which the measured potential P_ist falls below the defined threshold value P_sw and a subsequent point in time ZPc at which the measured potential P_ist again exceeds the defined threshold value P_sw can be measured. In FIG. 4, points in time ZPa-ZPc are shown in the upper diagram by way of example for the first cycle, consisting of a first time period Z1 and a subsequent second time period Z2. However, the determination is of course carried out continuously during the welding process, i.e. for a plurality of feed cycles C. The actual value f_ist of the droplet detachment frequency f corresponds to the time between the point in time ZPa and the point in time ZPc.

The determination of the actual values t1_ist, t2_ist of the times t1, t2 is preferably carried out continuously over time, but could also be carried out discretely over time, i.e. at certain defined intervals. The determination of the actual value P_ist, e.g. the measurement of the measuring voltage U_m or measuring current I_m, is preferably also carried out continuously or discretely. Time-discrete determination can, for example, be carried out in the time steps of the regulation described in more detail below. The middle diagram shows that a certain constant time t1_soll (or t2_soll) is predefined as the target value. According to the invention, the control unit 13 is designed to control the feed unit 7 correspondingly, so that at least one defined parameter of the feed speed v of the welding wire 8 in the feed cycles C is adjusted during welding such that the desired target value t1_soll, t2_soll or f_soll is achieved.

For example, an average feed speed vm of an entire feed cycle C can be used as a parameter of the feed speed v and/or an average positive feed speed vmZ1 of a feed cycle C and/or an average negative feed speed vmZ2 of a feed cycle C (with reversing wire feed). The average feed speed vm, the average positive feed speed vmZ1 and the average negative feed speed vmZ2 are shown by way of example in FIG. 3 for the first feed cycle C.

For example, the duration t1 of the first time period Z1 of a feed cycle C can be determined as the actual value t1_ist, wherein a target value t1_soll for the first duration t1 is used as the target value. Likewise, the duration t2 of the second time period Z2 of a feed cycle C can be determined as the actual value t2_ist and a target value t2_soll for the second duration t2 can be used as the target value. An actual value f_ist of the drop transfer frequency f can also be determined, which corresponds to the sum of the duration t1 of the first time period Z1 and the duration t2 of the second time period Z2 of a feed cycle C. A target value f_soll for the drop transfer frequency f can be used as the target value. In all three cases, one or more of the above-mentioned influencing parameters of the feed speed v can be changed in order to set the respective target value.

For this purpose, a suitable controller can advantageously be provided in the control unit 13, e.g. a PI controller or PID controller. The controller is designed to determine a manipulated variable S for the feed unit 7, in particular for the drive unit 7a, from the respectively determined actual value, e.g. the actual value t1_ist of the duration t1 of the first time periods Z1 (or the determined actual values t2_ist of the duration t2 of the second time periods Z2) and from the predefined, preferably constant, target value, e.g. t1_soll, t2_soll or f_soll. The control unit 13 then controls the feed unit 7 correspondingly with the determined manipulated variable S in order to control the feed speed v, as shown in FIG. 3.

This allows the short-circuit time t2 or the short-circuit-free time t1 to be adjusted to a desired value by continuously adjusting the defined parameter, e.g. the average feed speed vm and/or the average positive feed speed vmZ1 and/or, if applicable, the average negative feed speed vmZ2. This makes it possible to react automatically to the variable influencing parameters mentioned at the outset (e.g. variable distance X between electrode 4a and workpiece 10, variable angle a between electrode 4a and welding wire 8—see FIG. 2, or variable welding speed G in the direction of the weld seam 32—see FIG. 3), which leads to improved welding quality, especially during manual welding. If the welding speed G is, for example, unconsciously increased by the welder, this will usually lead to the short-circuit-free time t1 automatically increasing because there is less additive in the molten bath 26. As a result of the regulation according to the invention, for example, the average feed speed vm is increased and thus automatically adapted to the increased welding speed G (and vice versa).

The target value t2_soll for the short-circuit time t2, the target value t1_soll for the short-circuit-free time t1 and the target value f_soll for the droplet detachment frequency f can be assumed to be known and stored, for example as a fixed value in the control unit 13. The target value can also depend on a diameter of the welding wire 8 and/or on a material of the welding wire 8 and/or on an electrical welding parameter (e.g., the welding current I_s or the welding voltage U_s). Depending on the current welding parameter (which can be considered known due to the selected welding program), a corresponding target value can therefore be set automatically. In addition, the target value can also depend on the seam shape of the weld seam 32 to be produced (fillet weld, V-type weld, etc.).

For example, a function for the target value depending on at least one variable (e.g. the welding voltage I_s) can be stored in the control unit 13. The control unit 13 can then determine the target value from the function. If the target value depends on a variable, the function could, for example, be stored in the form of a characteristic curve. If the target value depends on several variables, the function could be stored as a characteristic diagram, for example. Of course, the welder can also make additional manual settings if necessary, e.g. via the user interface 14. For example, the preset target value could be increased or decreased by the welder based on a predefined range, e.g. a percentage range.

FIG. 4 shows that the duration of the individual feed cycles C as well as the level of the feed speed v in the respective feed cycles C change (in the present case they, in particular, decrease) automatically during regulation. While in the first cycle shown the error, i.e. the difference Δt1 between the actual value t1_ist and the target value t1_soll, is still relatively large, the error is reduced by adjusting the feed speed v until the actual value t1_ist, t2_ist adjusts to the predefined target value t1_soll, t2_soll. This is shown by way of example in the last and penultimate cycles in FIG. 4, where the error has been controlled to a sufficiently low value, preferably zero.

As shown in the lower diagram in FIG. 4, in order to change the average feed speed vm or the average positive feed speed vmZ1, it can be advantageous if, at the beginning of each feed cycle C, the feed speed v is initially set to a higher first positive value v1 for a certain boost time tu and, after the boost time tu has elapsed, is reduced to a relatively lower second positive value v2<v1. This has also proven to be advantageous due to the mass inertia of the welding wire 8 and welding torch 3. The first value v1 and/or the ratio between the first value v1 and the second value v2 and/or a length of the boost time tu can, for example, depend on the error Δt1 determined at the current point in time or in the current time step between the actual value t1_ist and the target value t1_soll (or on the error Δt2 between the determined actual value t2_ist and the target value t2_soll). The greater the respective difference Δt1, Δt2, the higher will be the first value v1 and/or the longer the time tu, as can be seen from the cycles shown. The relationship between the first value v1 and the second value v2 can therefore change during regulation, for example depending on the error Δt1 (or error Δt2).

However, the provision of a boost time tu with increased feed speed v1 is of course only optional and the average feed speed vm or the average positive feed speed vmZ1 could, for example, also be changed simply by changing the value v2.

As already mentioned, the invention is not limited to the described TIG welding method, but can also be applied to laser welding or TIG/laser hybrid welding or plasma welding.

1. A welding method, wherein energy is introduced into a workpiece in the region of a welding point by means of a non-consumable electrode as a heat source in order to produce a molten bath, wherein a welding wire separate from the heat source is fed to the molten bath, and wherein the welding wire is melted by the introduced energy in the region of the molten bath in order to produce a weld seam on the workpiece, wherein the welding wire is fed to the molten bath in intermittent feed cycles, preferably with a reversing feed speed, wherein, while the welding method is being carried out, an actual value of a duration of a first time period of a feed cycle is determined in each case, in which first time period the welding wire does not come into contact with the molten bath, and/or an actual value of a duration of a second time period of a feed cycle is determined in each case, in which second time period the welding wire does come into contact with the molten bath, and wherein at least one specified parameter of the feed speed of the welding wire is changed in the feed cycles depending on the determined actual value and a predefined target value, wherein the duration of the first time period of a feed cycle is determined as the actual value and a target value for the first duration is used as the target value, or the duration of the second time period of a feed cycle is determined as the actual value and a target value for the second duration is used as the target value, or a sum of the duration of the first time period and the duration of the second time period of a feed cycle is determined as the actual value and a target value for a drop transfer frequency is used as the target value.

2. The welding method according to claim 1, wherein an average feed speed of an entire feed cycle and/or an average positive feed speed of a feed cycle and/or an average negative feed speed of a feed cycle is used as a parameter of the feed speed.

3. The welding method according to claim 1, wherein the average feed speed or the average positive feed speed is changed by setting the feed speed to a defined first value for a defined boost time at the beginning of each feed cycle and by reducing it from the first value to a defined second value after the boost time has elapsed, wherein the first value and/or a ratio between the first value and the second value and/or a length of the boost time can preferably be set as a function of an error between the determined actual value and the predefined target value.

4. The welding method according to claim 1, wherein the energy is introduced into the workpiece via an electric arc produced between a non-consumable electrode and the workpiece and/or wherein the energy is introduced into the workpiece by a laser beam generated by laser optics.

5. The welding method according to claim 1, wherein the actual value of the duration of the first time period and/or the actual value of the duration of the second time period are determined continuously or discretely and/or wherein the predefined target value is adjusted by changing at least one parameter of the feed speed.

6. The welding method according to claim 1, wherein the target value is determined as a function of a diameter of the welding wire and/or of a material of the welding wire and/or of an electrical welding parameter, in particular of a welding current, and/or of a seam shape of the weld seam.

7. The welding method according to claim 1, wherein an electrical potential is tapped at the welding wire and wherein the actual value of the duration of the first time period and/or the actual value of the duration of the second time period is determined from a time profile of the detected electrical potential, wherein the electrical potential is preferably tapped by measuring a measuring voltage between the welding wire and the workpiece and/or an electric measuring current flowing through the welding wire, and the actual value of the duration of the first time period and/or the actual value of the duration of the second time period is determined from a time profile of the measuring voltage and/or of the measuring current, wherein, preferably, an electrical ground potential is generated between the welding wire and the workpiece.

8. A welding device comprising a welding torch with a non-consumable electrode as a heat source for introducing energy at a welding point on a workpiece in order to produce a molten bath, comprising a feed device for feeding a welding wire separate from the heat source to the molten bath, wherein the welding wire can be melted in the region of the molten bath by the energy introduced by the heat source in order to produce a weld seam on the workpiece and comprising a control unit for controlling the feed device, wherein the control unit is designed to control the feed device in such a way that the welding wire can be fed to the molten bath in intermittent feed cycles, preferably with a reversing feed speed, wherein a determination unit is provided which is designed to determine, during a welding method carried out with the welding device, an actual value of a duration of a first time period of a feed cycle in each case, in which first time period the welding wire does not come into contact with the molten bath and/or to determine an actual value of a duration of a second time period of a feed cycle in each case, in which second time period the welding wire does come into contact with the molten bath, and wherein the control unit is designed to control the feed device in order to change at least one specified parameter of the feed speed of the welding wire in the feed cycles depending on the determined actual value and on a predefined target value, wherein the actual value is the duration of the first time period of a feed cycle and the target value is a target value for the first duration or the actual value is the duration of the second time period of a feed cycle and the target value is a target value for the second duration or the actual value is a sum of the duration of the first time period and the duration of the second time period of a feed cycle and the target value is a target value for a drop transfer frequency.

9. The welding device according to claim 8, wherein the parameter of the feed speed comprises an average feed speed of an entire feed cycle and/or an average positive feed speed of a feed cycle and/or an average negative feed speed of a feed cycle.

10. The welding device according to claim 8, wherein the control unit is designed to set the feed speed to a defined first value for a defined boost time at the beginning of each feed cycle and to reduce the feed speed from the first value to a defined second value after the boost time has elapsed in order to change the average feed speed or the average positive feed speed, wherein the first value and/or a ratio between the first value and the second value and/or a length of the boost time are preferably defined as a function of an error between the determined actual value and the predefined target value.

11. The welding device according to claim 8, wherein the heat source comprises a non-consumable electrode for generating an electric arc between the electrode and the workpiece and/or wherein the heat source comprises laser optics for generating a laser beam.

12. The welding device according to claim 8, wherein the determination unit is designed to determine the actual value of the duration of the first time period and/or the actual value of the duration of the second time period continuously or discretely, wherein the determination unit is preferably integrated in the control unit, and/or wherein the control unit has a controller which is designed to determine a manipulated variable for the feed unit from the determined actual value and the predefined target value, and wherein the control unit is designed to control the feed unit with the determined manipulated variable in order to realize the target value.

13. The welding device according to claim 8, wherein the determination unit comprises a potential detection unit which is designed to tap an electrical potential on the welding wire which arises around the heat source, and wherein the determination unit is designed to determine the actual value of the duration of the first time period and/or the actual value of the duration of the second time period from a time profile of the detected electrical potential, wherein the potential detection unit preferably comprises a voltage measuring device for detecting a measuring voltage between the welding wire and the workpiece and/or a current measuring device for detecting an electrical measuring current flowing through the welding wire, wherein the determination unit is designed to determine the actual value of the duration of the first time period and/or the actual value of the duration of the second time period from a time profile of the measuring voltage or measuring current, wherein particularly preferably an auxiliary energy source is provided by which an electrical ground potential can be generated between the welding wire and the workpiece.

14. The welding device according to claim 8, wherein the target value depends on a diameter of the welding wire and/or on a material of the welding wire and/or on an electric welding parameter, and/or on a seam shape of the weld seam.
